(19) United States
(12) Patent Application Publication
(10) Pub. No.: US 2003/0185401 A1
(43) Pub. Date: Oct. 2, 2003

(54) Portable motion-activated electrical device that plays pre-recorded sounds, music, or noise

(76) Inventor: James A. Watson, Carlsbad, CA (US)

Correspondence Address: Steven W. Webb, Law Offices of Steven W. Webb, 655 Second Street, Encinitas, CA, 92024, US

(21) Appl. No.: 10/403,940

(22) Filed: Mar. 31, 2003

Related U.S. Application Data
(60) Provisional application No. 60/368,598, filed on Apr. 1, 2002.

(51) Int. Cl. H04R 29/00; H04R 3/02

(52) U.S. Cl. 381/58; 381/73.1

(57) ABSTRACT

A portable sound playing device is presented that can be used in any household or office setting, the sound playing device capable of playing masking sounds or music. This device is particularly useful in bathrooms for entertaining occupants or masking the sounds of bathroom activities. The functional housing can be both decorative and useful, coming in tissue dispenser, lotion dispenser, or stylish shapes.

### RELATED U.S. APPLICATIONS

This application supplements and completes Provisional Application 60/368,598, filed Apr. 1, 2002.

### BACKGROUND OF THE INVENTION

This invention relates to automated sound producing devices. In particular, the present invention is a sound broadcasting device that is triggered by a motion sensor, the sound produced used to mask other sounds or for entertainment.

### BRIEF SUMMARY OF THE INVENTION

The present invention consists of a box or chassis that can be programmed by means of a series of simple switches or buttons to play pre-selected, pre-recorded sounds or music. The box can be single purpose, containing only the sound producing mechanism and controls, or can be multiple purpose, combined with a tissue dispenser or lotion dispenser, for example.

The sounds or music can be stored in the box and selected by means of the switches. The sounds will be produced when motion is sensed near the invention, by means of a motion sensing device. The motion sensor can be of several different type, infrared, Doppler or others.

The invention is designed to be placed on a shelf, hung from a wall, or attached to furniture. The stand-alone versions are to be powered by internal batteries, but a version with a power cord running to household 110V AC power is envisioned. There is a proposed embodiment that is combined with a light switch, and can be powered externally by being connected to the local power wiring.

The motion sensor can be placed within the device, depending on the instantiation, to point up or to any of four sides. In one instantiation, the motion sensor is placed within a component rotatably attached to the body of the invention, so that the sensor can be pointed in one of several possible directions at the whim of the user.

The speaker component can be placed on any of the six possible sides of the box, including the bottom for a reflected sound effect. The speakers are single or in pairs.

One embodiment of the invention contains sound recording equipment, so that users can record specific messages, sounds or music into the system to be stored for replay. A microphone is included in one instantiation to permit recording of sounds by the user for later sensor-triggered playback. Not all embodiments will have this feature, and the basic invention is a playback only version.

The shelf mounted system can have soft feet on each corner or can use a suction cup device to hold the system on a shelf. Other attachment means for holding the device in one place are possible in this invention, including wall-mounting brackets, suspension devices, and the like.

### BRIEF DESCRIPTION OF THE DRAWINGS

The construction and operation of the invention can be readily appreciated from inspection of the drawings that accompany this application.

FIG. 1 is a perspective view of the invention.

FIG. 2 is a side cross-section of the invention.

FIG. 3 is front cross-section of the invention

FIG. 4A is the top part of the exploded view of the invention

FIG. 4B is the bottom part of the exploded view of the invention

### DETAILED SPECIFICATION

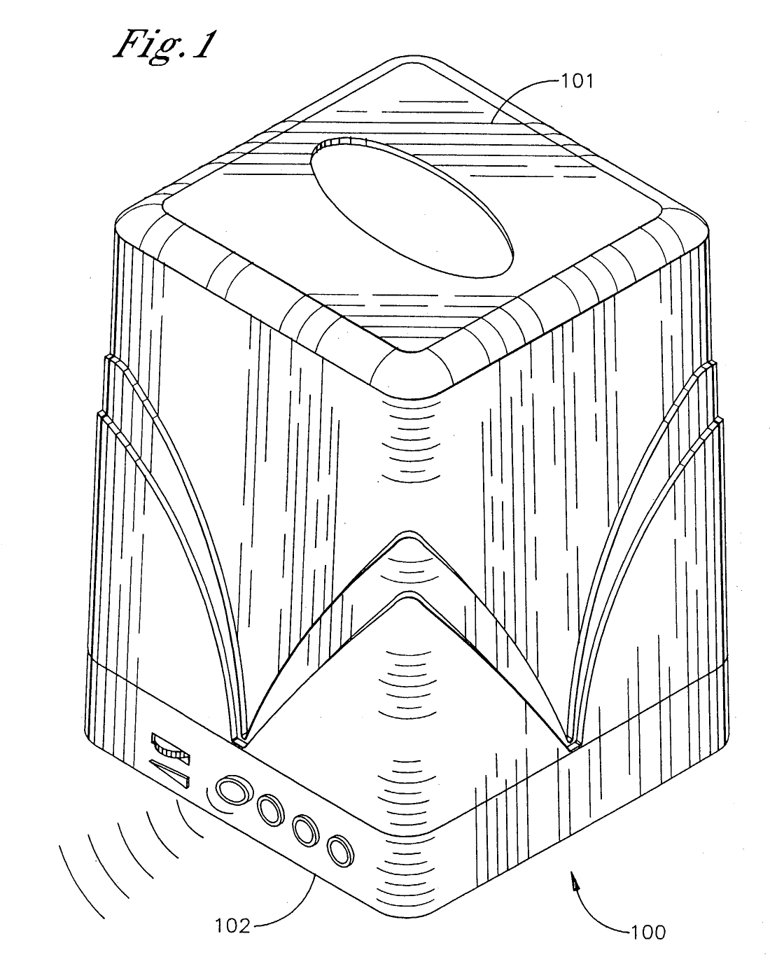

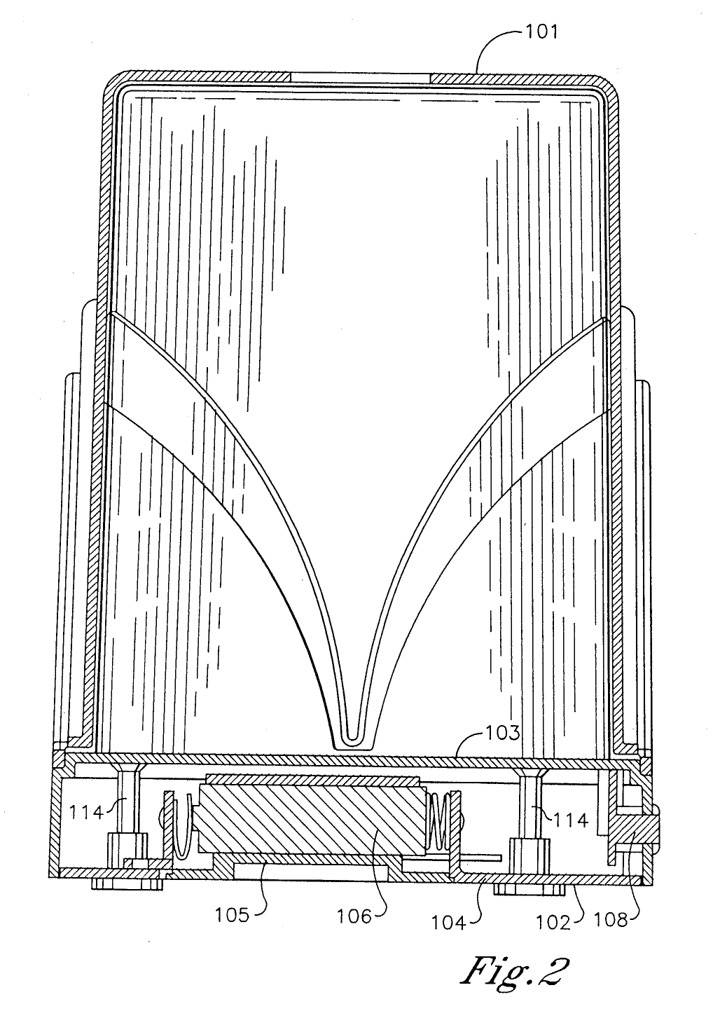

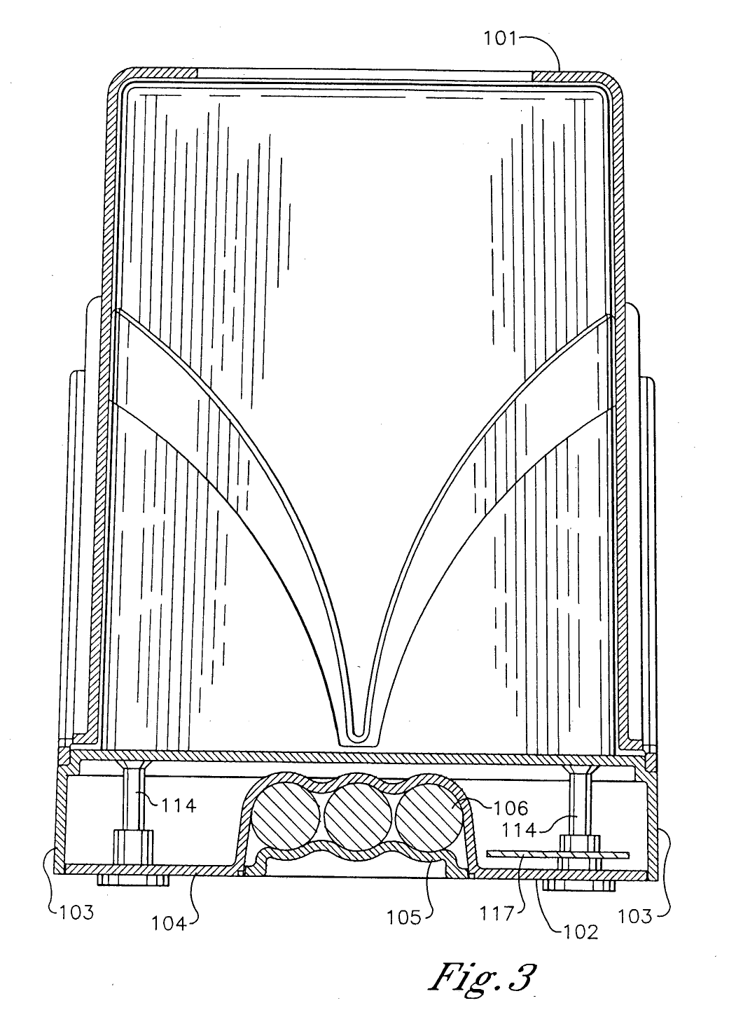

Referring to FIGS. 1 through 3, the present invention¹⁰⁰ consists of a decorative housing¹⁰¹ and a music-playing base¹⁰². The preferred embodiment has a removable decorative housing¹⁰¹ that is configured as a tissue dispenser.

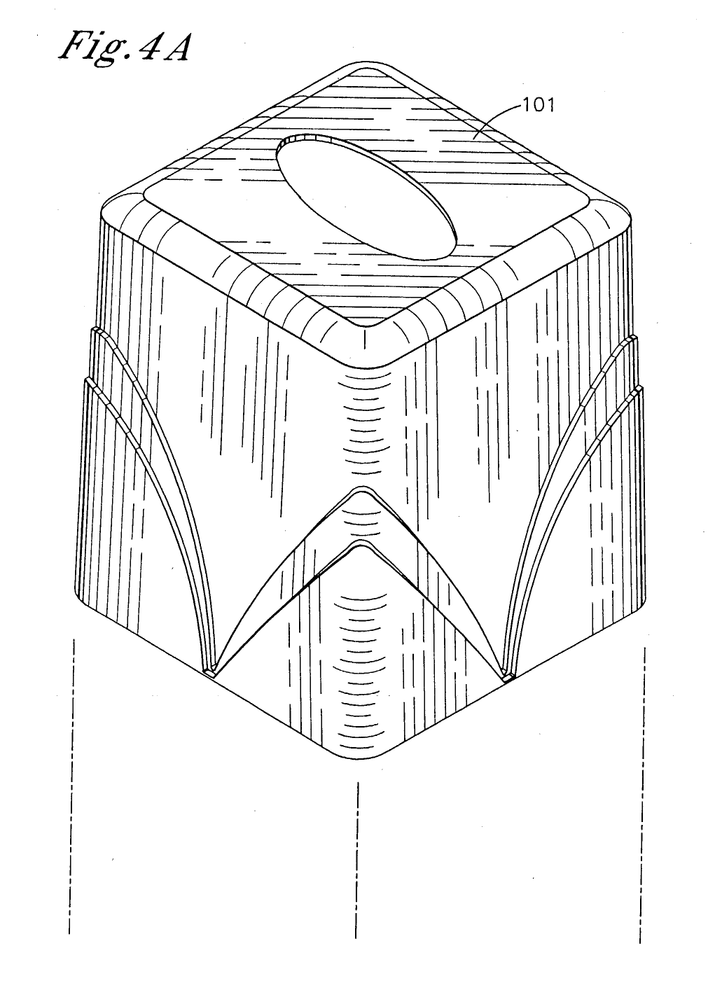

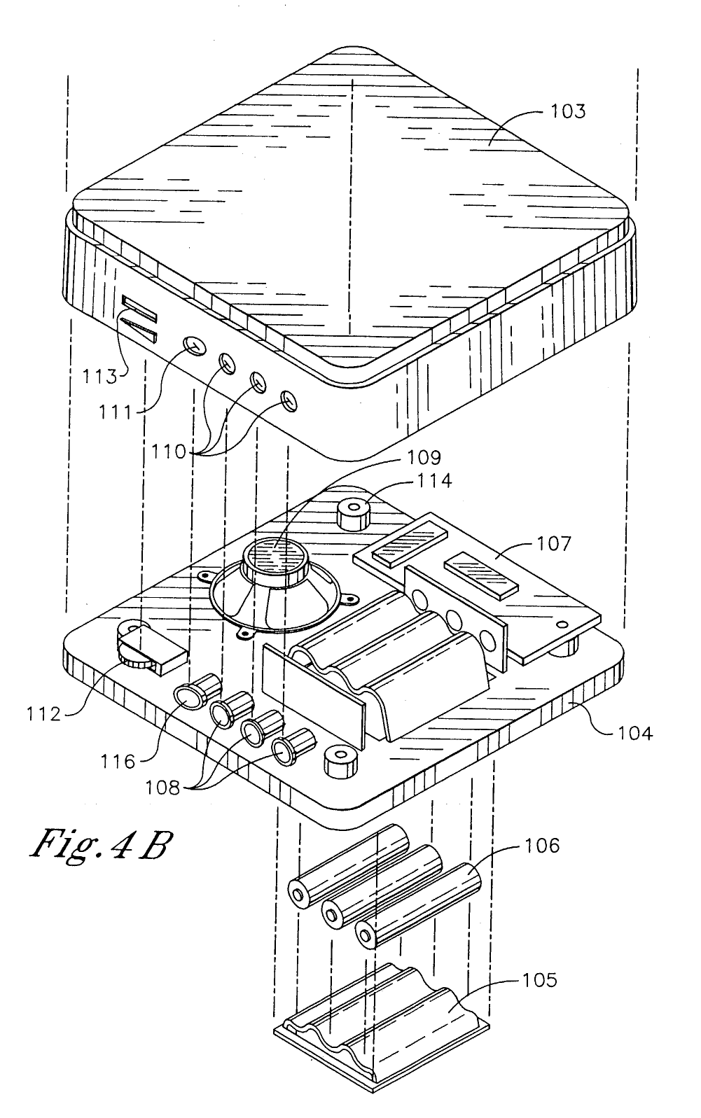

As shown in FIGS. 4A and 4B, the base in the preferred embodiment is a rectangular hollow housing¹⁰³ with a removable base plate¹⁰⁴. The electrical components of the invention are fixedly attached to the base plate¹⁰⁴ and the housing¹⁰³ is detachably connected to the base plate¹⁰⁴.

The base plate¹⁰⁴ has a removable battery door¹⁰⁵ to which batteries¹⁰⁶ can be removable attached. The battery door¹⁰⁵ is itself removable from the base plate¹⁰⁴ and can be hinged to the base plate¹⁰⁴ or completely detachable.

The electric circuitry¹⁰⁷ that plays/records the music and interprets the switches¹⁰⁸ is located as shown in FIG. 4B. The speaker¹⁰⁹ is positioned so that it opens outward from the housing base plate¹⁰⁴. The speaker can be a speaker/microphone. The switches¹⁰⁸ are positioned at the “front” of the base plate¹⁰⁴ and can be accessed when the base is closed up via the switch access holes¹¹⁰ at the “front” of the housing.

The sensor¹¹⁶ is positioned as shown in FIG. 4B on the base plate¹⁰⁴ so that it can receive auditory/infrared/other signals from the external environment via the sensor hole¹¹¹. The volume control¹¹² is located on the base plate¹⁰⁴ so that it protrudes through the volume control access hole¹¹³.

When the housing base plate¹⁰⁴ is secured to the base housing¹⁰³ via the base plate securing means¹¹⁴, in the preferred embodiment screws and screw holes, the music-playing base is water-tight and sturdy, so that rough handling will not jar loose any components.

The present invention is operated in the preferred embodiment by means of the switches¹⁰⁸, the volume control¹¹², and the sensor¹¹⁶. Depending on the settings made with the switches, the invention can be turned on or off, set to operate when the sensor detects a sensed event, and placed in other modes.

The present invention in its preferred embodiment is portable and can be placed on any flat surface. In the preferred embodiment, the decorative housing¹⁰¹ can be used as a tissue dispenser by detaching it from the base¹⁰² and stacking appropriately-sized tissues in the enclosed space.

Alternate embodiments of this invention include where the decorative housing¹⁰¹ can be a lotion dispenser, a potpourri holder, and a wall-mounted unit connected to household AC power. The speaker/microphone¹⁰⁹ can be used to record sounds for storage in the electric circuitry¹⁰⁷.

While the foregoing describes a preferred embodiment and several alternate embodiments, variation on this design and equivalent designs may be resorted to in the scope and spirit of the claimed invention.

What is claimed is:

1. Portable sound system for home or workplace use, said sound system comprising
a power system providing electrical power to the sound system,
a sensor system that provides a signal based on a sensed condition, said sensed condition to be selected from a set composed of motion, change in ambient light, presence of a heat source, or other physical phenomena,
a sound recording system,
a sound storage system,
a sound playback system,
a functional housing,
a set of control switches, said control switches to include one or more control switches from a set composed of on/off, record, playback, automatic operation, set type of sound, and other control modes,
a controller system that controls operation of the portable sound system based on the settings of control switches and the signal received from the sensor system,
said portable sound system operated by placing the portable sound system in a convenient place near where people will enter or leave, selecting pre-recorded sounds or music, recording sounds or music and then selecting the recorded sounds or music for playback, and then setting the portable sound system to an automatic mode, said sound system to be activated to play back sounds or music by the entry, presence, or leaving of people from the room where the sound system is placed.

2. The portable sound system of claim 1, where the functional housing is selected from the set composed of tissue dispenser, lotion dispenser, wall-mounting, or aesthetically pleasing.

3. The portable sound system of claim 1 where the power system consists of batteries.

4. The portable sound system of claim 1 where the power system is 110 volt household AC power.

5. The portable sound system of claim 1 where the sound recording system is a speaker/microphone and a tape recorder.
